(19) United States
(12) Patent Application Publication
(10) Pub. No.: US 2012/0178318 A1
(43) Pub. Date: Jul. 12, 2012

(54) Inlet Grate Cleaning System for a Water Jet Propulsion System

(75) Inventors: Mihai Rasidescu, Sherbrooke (CA); Roger Rioux, Sherbrooke (CA); Eric Menard, Rock Forest (CA); Patrice Dusablon, Cocoa Beach, FL (US)

(73) Assignee: CONSORTIUM DE RECHERCHE BRP-UNIVERSITE DE SHERBROOKE S.E.N.C., Sherbrookec, QC (CA)

(21) Appl. No.: 13/497,210

(22) PCT Filed: Sep. 30, 2009
(86) PCT No.: PCT/CA09/01384

§ 371 Date: Mar. 20, 2012

(51) Int. Cl. B63H 11/01; B08B 3/02; B63H 25/46; B08B 3/00

(52) U.S. Cl. 440/46; 134/184; 134/34

(57) ABSTRACT

An inlet grate cleaning system for a water jet propulsion system to be used in a watercraft. The water jet propulsion system has a water passage, the water passage has an inlet and the inlet has a forward area and a rearward area with respect to the watercraft. The inlet grate cleaning system comprises a pump and at least one water intake fluidly connected to the pump. At least one water outlet is also fluidly connected to the pump. The pump is adapted for pumping water from the at least one water intake to the at least one water outlet to create at least one jet of water. The at least one water outlet is positioned so as to direct the at least one jet of water toward an inlet grate.

### FIELD OF THE INVENTION

The present invention relates to an inlet grate cleaning system for a water jet propulsion system and to a watercraft having such a system.

### BACKGROUND OF THE INVENTION

Water jet powered watercraft have become very popular in recent years for recreational use and for use as transportation in coastal communities. Water jet propelled watercraft offer high performance, improved acceleration and handling, and shallow-water operation. Accordingly, personal watercrafts (PWCs), which typically employ water jet propulsion units, have become popular, especially in resort areas. As the use of PWCs has increased, a desire for improved performance, including greater operational efficiency, also has increased.

Typically, water jet powered watercraft, such as PWCs, have a water jet propulsion system mounted within the hull that ingests water from a body of water and expels the water at a high velocity from the stern to propel the watercraft. For directional control, a nozzle is generally provided at the outlet of the jet pump and turning is achieved by redirecting the flow of water from the nozzle.

In the typical arrangement for a water jet propulsion unit, an engine output shaft is rotationally coupled to a drive shaft. The drive shaft extends into a water passage, which is defined in part by the hull of the watercraft partially below the water line. The water passage extends from a point forward of the rear of the watercraft to the rear of the watercraft. An impeller disposed within a pump housing portion of the water passage is attached to the drive shaft.

FIG. 8 shows a prior art water jet propulsion system 600 disposed within a hull 612, of which only a portion is shown in broken lines. As shown in FIG. 8, an inlet grate 642 is disposed at an inlet 686 to an intake ramp 688. A pump support 650 or ride shoe forms the bottom portion 692 of the water intake ramp 688. The pump support 650 is coupled to the hull 612 within a tunnel 694 through fasteners and/or adhesives (not shown). The pump support 650 includes a main body portion having a vertical attachment surface 652, a forward attachment location 654 that is secured to a ride plate 696, and a ramp portion 656. The ramp portion 656 forms the bottom portion 692 of the water intake ramp 688.

From the water intake ramp 688, water enters into a jet pump 660. The jet pump 660 includes an impeller 670 and a stator 680. The impeller includes blades 672 that extend from a center portion 674 that is coupled to an engine by one or more shafts 698, such as a drive shaft and/or an impeller shaft. The rotation of the impeller 670 pressurizes the water, which then moves over the stator 680 that comprises a plurality of fixed stator blades 682. The role of the stator blades 682 is to decrease the rotational motion of the water so that almost all the energy given to the water is used for thrust, as opposed to swirling the water. As shown, the impeller 670 and the stator 680 are both disposed within a jet propulsion unit housing 690 or pump housing. However, it is also known to position the stator 680 at a position outside of the housing 690 at a position downstream of the housing 690. The housing 690 includes a peripheral wall 691 which defines a passage through which water passes. A forward end 692 of the housing peripheral wall 691 is attached to the vertical attachment surface 654 or the pump support 650. The forward end 692 of the housing peripheral wall 691 defines the inlet into the housing 690.

Once the water leaves the jet pump 660, it goes through a venturi 610 disposed at the rearward end of the housing 690. Since the venturi's exit diameter is smaller than its entrance diameter, the water is accelerated further, thereby providing more thrust.

A steering nozzle 602 is pivotally attached to the venturi 610 so as to pivot about a vertical axis 604. The steering nozzle 602 is operatively connected to a steering mechanism such as a steering handlebar (see, e.g., the steering handlebar 74 shown in FIG. 1). Rotation of the steering handlebar causes the steering nozzle 602 to pivot around the vertical axis 604, thereby directing the water discharge to result in a change in the steering direction of the watercraft.

A water passage 695, through which water flows, is illustrated in FIG. 8. With reference to FIG. 8, the water flows from left to right through the passage 695. Moving from left to right in this illustration, which corresponds to upstream and downstream positions, the water passage 695 is defined by the inlet 686, the water intake ramp 688, the pump support passage, the jet pump 660, the venturi 610 and the steering nozzle 602.

The inlet grate 642 usually comprises a plurality of elongated members 643 extending longitudinally across the inlet 686. Elongated members 643 prevent large rocks, weeds, and other debris from entering the water intake ramp 688 and passing through the water passage 695, which could result in breaking or premature use of the various components of the water jet propulsion unit 600. However, depending on the PWC operating conditions, weeds and debris may get stuck in the inlet grate 642 and limit the amount of water entering the water passage 695 through the inlet 686. This may results in decreased acceleration performance, traveling speed and/or maneuverability. To solve this problem, the operator of the PWC or someone assisting has to manually pull out the objects blocking the proper flow of water through the inlet 686.

In view of the foregoing, a need has developed for a watercraft with a water jet propulsion system that provides for a cleaning system for cleaning objects stuck in the inlet grate. In order to address this need, water jet propulsion systems with inlet grates pivotally mounted to the hull of the PWC have been developed. These systems allow for the repeated lowering of the inlet grate until objects stuck to or between the elongated members are loosened and eventually removed from the inlet grate. However, such a system has not proved to provide satisfactory performances since some objects may nonetheless remain stuck or the number of actuations of the grate necessary to remove some objects is too high.

Therefore, there is still a need for an inlet grate cleaning system.

### SUMMARY OF THE INVENTION

It is an object of the present invention to ameliorate at least some of the inconveniences present in the prior art.

In one aspect, the invention provides an inlet grate cleaning system for a water jet propulsion system to be used in a watercraft. The water jet propulsion system has a water passage, the water passage has an inlet and the inlet has a forward area and a rearward area with respect to the watercraft. The inlet grate cleaning system comprises a pump and at least one water intake fluidly connected to the pump. At least one water outlet is also fluidly connected to the pump. The pump is adapted for pumping water from the at least one water intake to the at least one water outlet to create at least one jet of water. The at least one water outlet is positioned so as to direct the at least one jet of water toward an inlet grate.

In an additional aspect, the at least one water outlet includes a nozzle.

In a further aspect, the inlet grate cleaning system further comprises an inlet grate.

The inlet grate comprises a first end portion adapted to be connected to one of the forward area and the rearward area of the inlet. At least one elongated member extends from the first end portion toward the other of the forward area or the rearward area of the inlet. The at least one elongated member is pivotally mounted to the first end portion of the inlet grate.

In an additional aspect, the at least one water outlet is positioned at the first end portion of the inlet grate.

In a further aspect, the at least one water outlet includes a nozzle.

In an additional aspect, the inlet grate cleaning system further comprises an actuator operatively connected to the at least one elongated member to pivot the at least one elongated member of the inlet grate between a first position and at least a second position.

In a further aspect, the inlet grate cleaning system further comprises a device operatively connected to the actuator for controlling the operation of the actuator.

In another aspect, the inventions provides a watercraft comprising a hull, a deck disposed on the hull and a water jet propulsion system connected to the hull. The water jet propulsion system has a water passage, the water passage has an inlet and the inlet has a forward area and a rearward area with respect to the watercraft. An engine is supported by the hull and adapted to drive the water jet propulsion system. An inlet grate is disposed in the inlet. A pump is connected to one of the hull or the deck. At least one water intake is fluidly connected to the pump. At least one water outlet is fluidly connected to the pump. The pump is adapted for pumping water from the at least one water intake to the at least one water outlet to create at least one jet of water and the at least one water outlet is positioned so as to direct the at least one jet of water toward the inlet grate.

In an additional aspect, at least one portion of the inlet grate is pivotally mounted to one of the forward area of the inlet or the rearward area of the inlet.

In a further aspect, the watercraft further comprises an actuator operatively connected to the at least one portion of the inlet grate. The actuator is adapted to cause the at least one portion of the inlet grate to pivot between a first position and at least a second position away from the hull.

In an additional aspect, the watercraft further comprises a device operatively connected to the actuator for controlling the operation of the actuator. The device is disposed on the deck so as to be within reach of an operator of the watercraft.

In a further aspect, the inlet grate has a first end portion adapted to be connected to one of the forward area or the rearward area of the inlet and at least one elongated member extending from the first end portion toward the other of the forward area or the rearward area of the inlet. The at least one elongated member is pivotally mounted to the first end portion of the inlet grate.

In an additional aspect, the watercraft further comprises an actuator operatively connected to the at least one elongated member to pivot the at least one elongated member of the inlet grate between a first position and at least a second position away from the hull.

In a further aspect, the watercraft further comprises a device operatively connected to the actuator for controlling the operation of the actuator. The device is disposed on the deck so as to be within reach of an operator of the watercraft.

In an additional aspect, the watercraft further comprises a straddle seat disposed on the deck and a handlebar operatively connected to the jet propulsion system for steering the watercraft.

In a further aspect, the water jet propulsion system is a first water jet propulsion system having a first water passage, the first water passage having a first inlet, the inlet grate is a first inlet, the at least one water outlet is at least one first water outlet. The watercraft further comprises a second water jet propulsion system having a second water passage, the second water passage having a second inlet, a second inlet grate disposed in the second inlet and at least one second water outlet fluidly connected to the pump. The pump is adapted for pumping water from the at least one water intake to the at least one second water outlet to create at least one second jet of water. The at least one second water outlet is positioned so as to direct the at least one second jet of water toward the second inlet grate.

In an additional aspect, the first inlet and the second inlet are on opposite sides of a longitudinal axis of the watercraft.

In another aspect, the inventions provides a method for cleaning an inlet grate for a water jet propulsion system to be used in a watercraft. The water jet propulsion system has a water passage, the water passage has an inlet, the inlet has a forward area and a rearward area with respect to the watercraft, and an inlet grate is disposed in the inlet. The method for cleaning an inlet grate comprises the step of pumping water through a water intake from a body of water in which the watercraft is operated to at least one water outlet to create at least one jet of water directed toward the inlet grate.

In an additional aspect, the inlet grate has an end portion connected to the inlet and at least one elongated member extends from the end portion. The method for cleaning an inlet grate further comprises the step of pivoting the at least one elongated member of the inlet grate between a first position and at least a second position away from the hull of the watercraft, the at least one jet of water being directed toward the at least one elongated member when the at least one elongated member is in the at least second position.

For purposes of this application, the terms related to spatial orientation such as forwardly, rearwardly, left and right, are as they would normally be understood by a driver of a vehicle sitting thereon in a normal driving position.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 illustrates a left side elevation view of a personal watercraft in accordance with an embodiment of the invention;

FIG. 2 is a top plan view of the watercraft of FIG. 1;

FIG. 3 is a front elevation view of the watercraft of FIG. 1;

FIG. 4 is a rear elevation view of the watercraft of FIG. 1;

FIG. 5 is a bottom plan view of the hull of the watercraft of FIG. 1;

FIG. 6 is a perspective view, taken from a front, left side, of a sport boat in accordance with an embodiment the invention;

FIG. 7 is a perspective view, taken from a rear, left side, of the sport boat of FIG. 6;

FIG. 8 is a partial, cross-sectional side view of the stern of a watercraft showing a prior art water jet propulsion system;

FIG. 9 is a partial, cross-sectional side view of the stern of the sport boat of FIG. 6 showing an embodiment of a water jet propulsion system in accordance with an embodiment of the invention;

FIG. 10 is a bottom perspective view, taken from rear, left side, of a portion of the hull of the sport boat of FIG. 6 with the elongated members of the inlet grate in a first closed position;

FIG. 11 is another bottom perspective view, taken from rear, left side, of the portion of the hull of FIG. 10 with the elongated members of the inlet grate in a second opened position;

FIG. 12 is a schematic representation of an inlet grate cleaning system in accordance with an embodiment of the invention;

FIG. 13 is a top view of a portion of an interior of the hull of the sport boat of FIG. 6 in accordance with an embodiment of the invention.

### DETAILED DESCRIPTION OF THE PREFERRED EMBODIMENTS

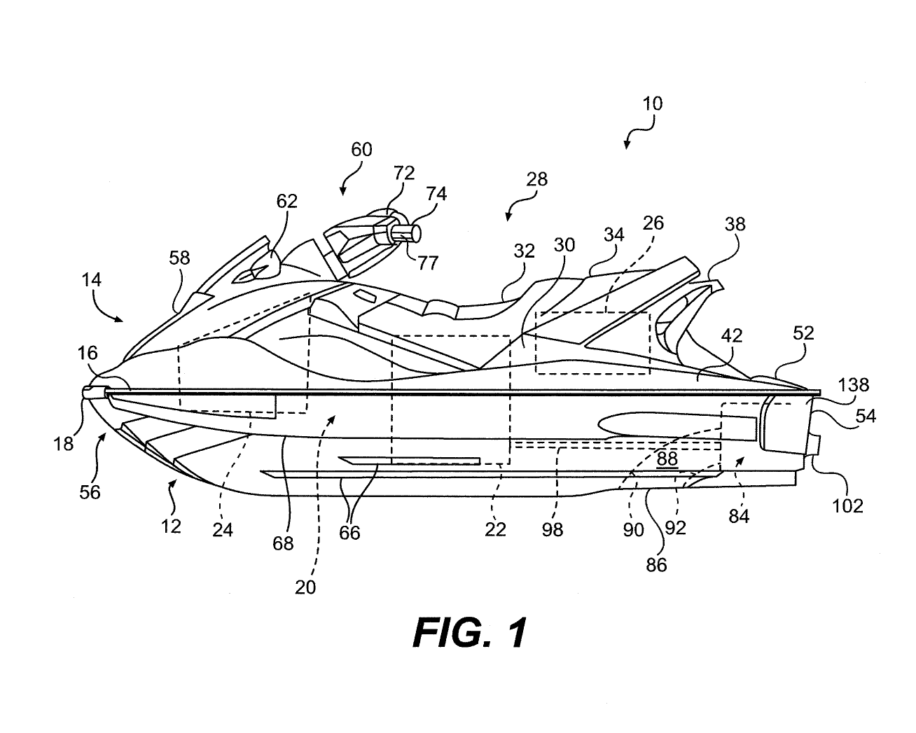

The general construction of a personal watercraft 10 in accordance with this invention will be described with respect to FIGS. 1-5. The following description relates to one way of manufacturing a personal watercraft. Obviously, those of ordinary skill in the watercraft art will recognize that there are other known ways of manufacturing and designing watercraft and that this invention would encompass these other known ways and designs.

The watercraft 10 of FIG. 1 is made of a hull 12 and a deck 14. The hull 12 buoyantly supports the watercraft 10 in the water. The deck 14 is designed to accommodate one or multiple riders. The hull 12 and deck 14 are joined together at a seam 16 that joins the parts in a sealing relationship. Preferably, the seam 16 comprises a bond line formed by an adhesive. Of course, other known joining methods could be used to sealingly engage the parts together, including but not limited to thermal fusion, molding or fasteners such as rivets or screws. A bumper 18 generally covers the seam 16, which helps to prevent damage to the outer surface of the watercraft 10 when the watercraft 10 is docked, for example. The bumper 18 can extend around the bow, as shown, or around any portion or all of the seam 16.

The space between the hull 12 and the deck 14 forms a volume commonly referred to as the engine compartment 20 (shown in phantom). The engine compartment 20 accommodates an engine 22, as well as a muffler, tuning pipe, gas tank, electrical system (battery, electronic control unit, etc.), air box, storage bins 24, 26, and other elements required or desirable in the watercraft 10.

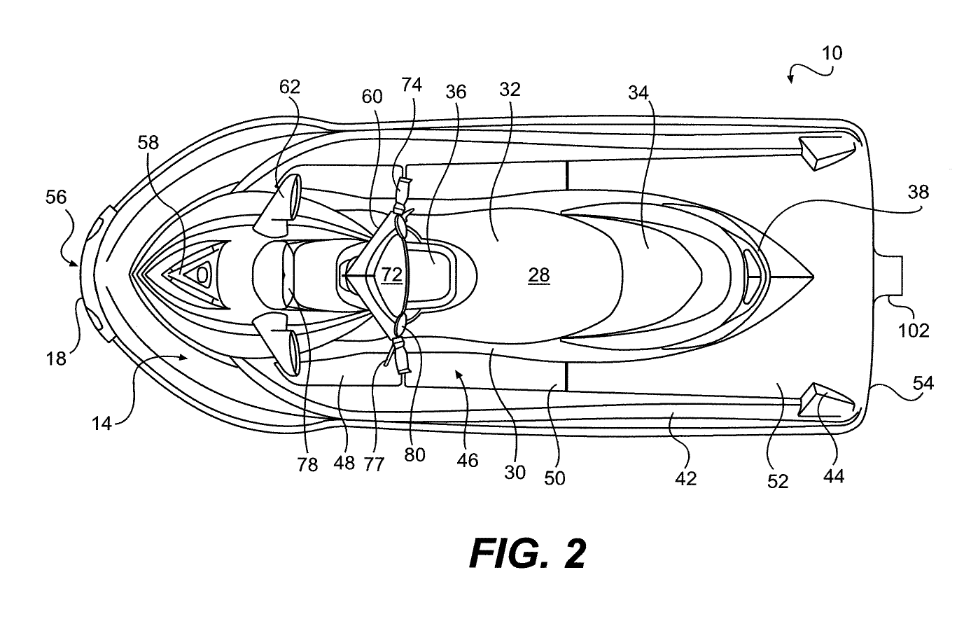

As seen in FIGS. 1 and 2, the deck 14 has a centrally positioned straddle-type seat 28 positioned on top of a pedestal 30 to accommodate multiple riders in a straddling position. As seen in FIG. 2, the seat 28 includes a first, front seat portion 32 and a rear, raised seat portion 34. The seat 28 is preferably made as a cushioned or padded unit, or as interfitting units. The first and second seat portions 32, 34 are removably attached to the pedestal 30 by a hook and tongue assembly (not shown) at the front of each seat and by a latch assembly (not shown) at the rear of each seat, or by any other known attachment mechanism. The seat portions 32, 34 can be individually tilted or removed completely. Seat portion 32 covers an engine access opening defined by a top portion of the pedestal 30 to provide access to the engine 22 (FIG. 1). Seat portion 34 covers a removable storage box 26 (FIG. 1). A “glove compartment” or small storage box 36 is provided in front of the seat 28.

As seen in FIG. 4, a grab handle 38 is provided between the pedestal 30 and the rear of the seat 28 to provide a handle onto which a passenger may hold. This arrangement is particularly convenient for a passenger seated facing backwards for spotting a water skier, for example. Beneath the handle 38, a tow hook 40 is mounted on the pedestal 30. The tow hook 40 can be used for towing a skier or floatation device, such as an inflatable water toy.

As best seen in FIGS. 2 and 4, the watercraft 10 has a pair of generally upwardly extending walls located on either side of the watercraft 10 known as gunwales or gunnels 42. The gunnels 42 help to prevent the entry of water in the footrests 46 of the watercraft 10, provide lateral support for the riders' feet, and also provide buoyancy when turning the watercraft 10, since personal watercraft roll slightly when turning. Towards the rear of the watercraft 10, the gunnels 42 extend inwardly to act as heel rests 44. A passenger riding the watercraft 10 facing towards the rear, to spot a water-skier for example, may place his or her heels on the heel rests 44, thereby providing a more stable riding position. Heel rests 44 could also be formed separately from the gunnels 42.

Located on both sides of the watercraft 10, between the pedestal 30 and the gunnels 42 are the footrests 46. The footrests 46 are designed to accommodate the riders' feet in various riding positions. To this effect, the footrests 46 each have a forward portion 48 angled such that the front portion of the forward portion 48 (toward the bow of the watercraft 10) is higher than the rear portion of the forward portion 48. The remaining portions of the footrests 46 are generally horizontal. Of course, any contour conducive to a comfortable rest for the riders could be used. The footrests 46 are covered by carpeting 50 made of a rubber-type material, for example, to provide additional comfort and traction for the feet of the riders.

A reboarding platform 52 is provided at the rear of the watercraft 10 on the deck 14 to allow the rider or a passenger to easily reboard the watercraft 10 from the water. Carpeting or some other suitable covering may cover the reboarding platform 52. A retractable ladder (not shown) may be affixed to the transom 54 to facilitate boarding the watercraft 10 from the water onto the reboarding platform 52.

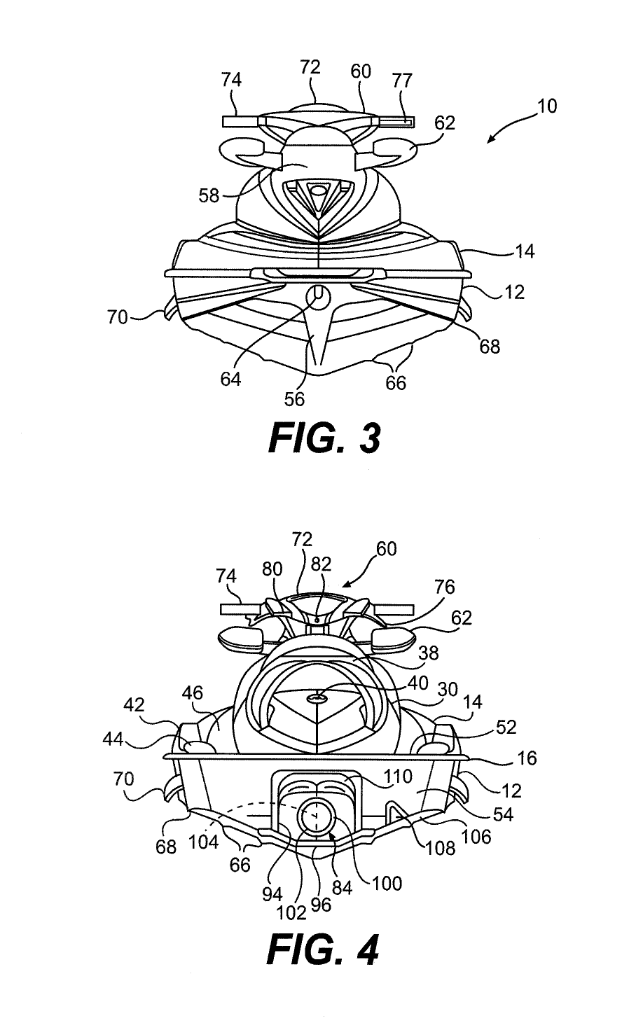

Referring to the bow 56 of the watercraft 10, as seen in FIGS. 2 and 3, the watercraft 10 is provided with a hood 58 located forwardly of the seat 28 and a helm assembly 60. A hinge (not shown) is attached between a forward portion of the hood 58 and the deck 14 to allow hood 58 to move to an open position to provide access to the front storage bin 24 (FIG. 1). A latch (not shown) located at a rearward portion of hood 58 locks hood 58 into a closed position. When in the closed position, hood 58 prevents water from entering front storage bin 24. Rearview mirrors 62 are positioned on either side of hood 58 to allow the rider to see behind the watercraft 10. A hook 64 is located at the bow 56 of the watercraft 10. The hook 64 is used to attach the watercraft 10 to a dock when the watercraft 10 is not in use or to attach to a winch when loading the watercraft 10 on a trailer, for instance.

As best seen in FIGS. 3, 4, and 5, the hull 12 is provided with a combination of strakes 66 and chines 68. A strake 66 is a protruding portion of the hull 12. A chine 68 is the vertex formed where two surfaces of the hull 12 meet. The combination of strakes 66 and chines 68 provide the watercraft 10 with its riding and handling characteristics.

Sponsons 70 are located on both sides of the hull 12 near the transom 54. The sponsons 70 have an arcuate undersurface that gives the watercraft 10 both lift while in motion and improved turning characteristics. The sponsons 70 are fixed to the surface of the hull 12 and can be attached to the hull 12 by fasteners or molded therewith. It is contemplated that the position of the sponsons 70 with respect to the hull 12 may be adjustable to change the handling characteristics of the watercraft 10 and accommodate different riding conditions. Trim tabs, which are commonly known, may also be provided at the transom and may be controlled from the helm 60.

As best seen in FIGS. 3 and 4, the helm assembly 60 is positioned forwardly of the seat 28. The helm assembly 60 has a central helm portion 72, that is padded, and a pair of steering handles 74, also referred to as a handlebar. One of the steering handles 74 is provided with a throttle operator 76, which allows the rider to control the engine 22, and therefore the speed of the watercraft 10. The throttle operator 76 can be in the form of a thumb-actuated throttle lever (as shown), a finger-actuated throttle lever, or a twist grip. The throttle operator 76 is movable between an idle position and multiple actuated positions. In a preferred embodiment, the throttle operator 76 is biased towards the idle position, such that, should the driver of the watercraft 10 let go of the throttle operator 76, it will move to the idle position. The other of the steering handles 74 is provided with a reverse gate operator 77 used by the driver to actuate a reverse gate 110 of the watercraft 10 as described in greater detail below. The reverse gate operator 77 is a finger-actuated lever. However, it is contemplated that the reverse gate operator 77 could be a thumb-actuated lever or a twist grip.

As seen in FIG. 2, a display area or cluster 78 is located forwardly of the helm assembly 60. The display cluster 78 can be of any conventional display type, including a liquid crystal display (LCD), dials or LED (light emitting diodes). The central helm portion 72 has various buttons 80, which could alternatively be in the form of levers or switches, that allow the driver to modify the display data or mode (speed, engine rpm, time . . . ) on the display cluster 78 or to change a condition of the watercraft 10, such as trim (the pitch of the watercraft 10).

The helm assembly 60 is provided with a key receiving post 82 located near a center of the central helm portion 72. The key receiving post 82 is adapted to receive a key (not shown) that starts the watercraft 10. As is known, the key is typically attached to a safety lanyard (not shown). It should be noted that the key receiving post 82 may be placed in any suitable location on the watercraft 10.

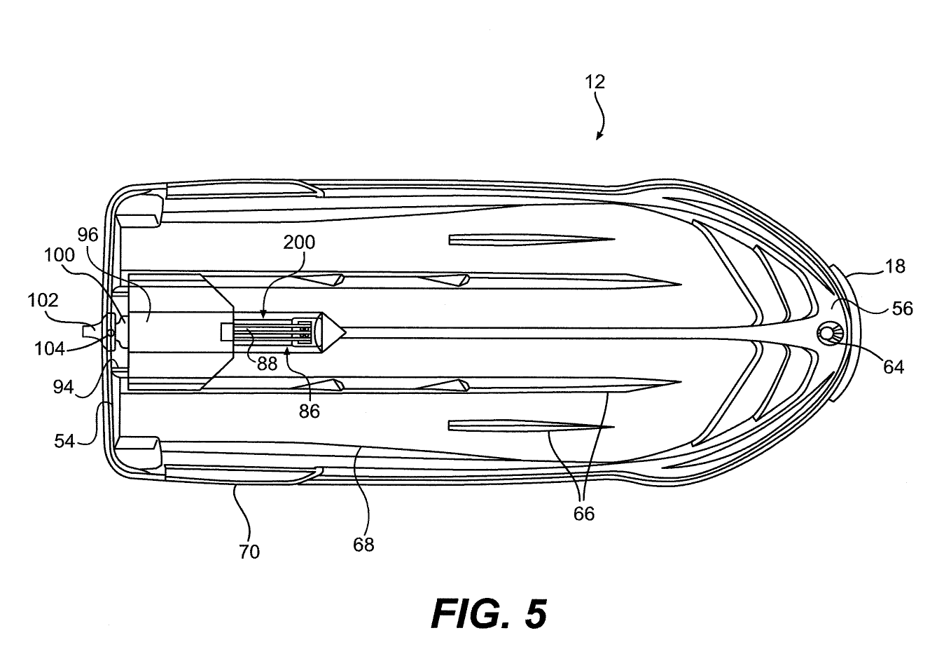

Returning to FIGS. 1 and 5, the watercraft 10 is propelled by a water jet propulsion system 84. As is known, the water jet propulsion system 84 pressurizes water to create thrust. The water is first scooped from under the hull 12 through an inlet 86, which has an inlet grate 200. The inlet grate 200 prevents large rocks, weeds, and other debris from entering the water jet propulsion system 84, which may damage the system or negatively affect performance. The inlet grate 200 will be described in greater detail below. Water flows from the inlet 86 through a water intake ramp 88. The top portion 90 of the water intake ramp 88 is formed by the hull 12, and a ride shoe (not shown in detail) forms its bottom portion 92. Alternatively, the intake ramp 88 may be a single piece or an insert to which the jet pump (not shown) of the water jet propulsion system 84 attaches. In such cases, the intake ramp 88 and the jet pump are attached as a unit in a recess in the bottom of hull 12.

From the intake ramp 88, water enters the jet pump. The jet pump is located in a formation in the hull 12, referred to as the tunnel 94. The tunnel 94 is defined at the front, sides, and top by the hull 12 and is open at the transom 54. The bottom of the tunnel 94 is closed by the ride plate 96. The ride plate 96 creates a surface on which the watercraft 10 rides or planes at high speeds.

The jet pump includes an impeller (not shown) and a stator (not shown). The impeller is coupled to the engine 22 by one or more shafts 98, such as a driveshaft and an impeller shaft. The rotation of the impeller pressurizes the water, which then moves over the stator that is made of a plurality of fixed stator blades (not shown). The role of the stator blades is to decrease the rotational motion of the water so that almost all the energy given to the water is used for thrust, as opposed to swirling the water. Once the water leaves the jet pump, it goes through a venturi 100. Since the venturi's exit diameter is smaller than its entrance diameter, the water is accelerated further, thereby providing more thrust. A steering nozzle 102 is pivotally attached to the venturi 100 so as to pivot about a vertical axis 104. The steering nozzle 102 could also be supported at the exit of the tunnel 94 in other ways without a direct connection to the venturi 100. Moreover, the steering nozzle 102 can be replaced by a rudder or other diverting mechanism disposed at the exit of the tunnel 94 to selectively direct the thrust generated by the water jet propulsion system 84 to effect turning.

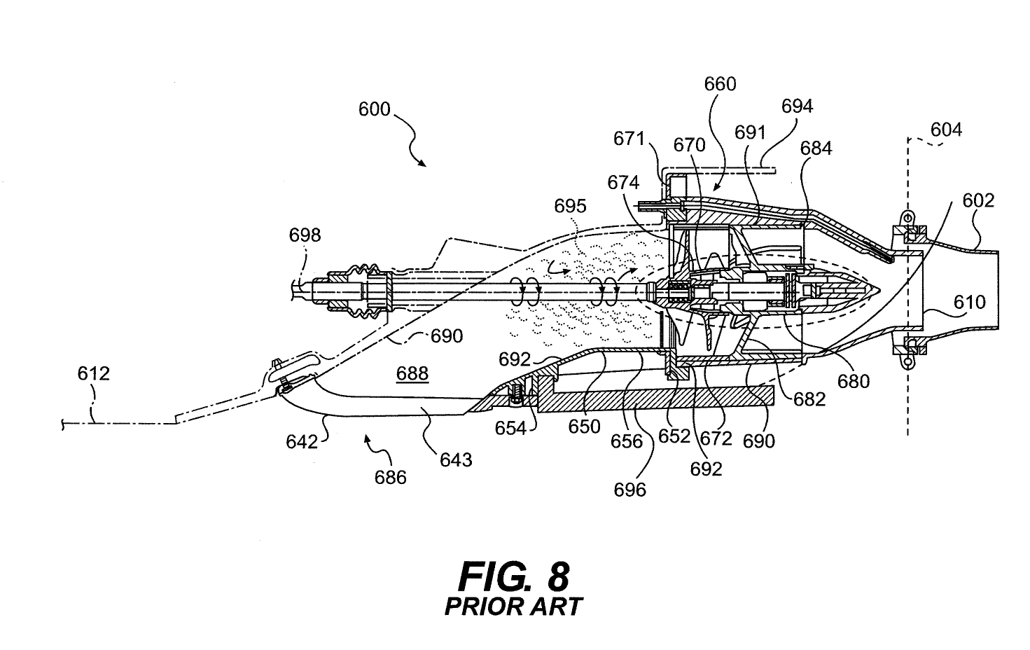

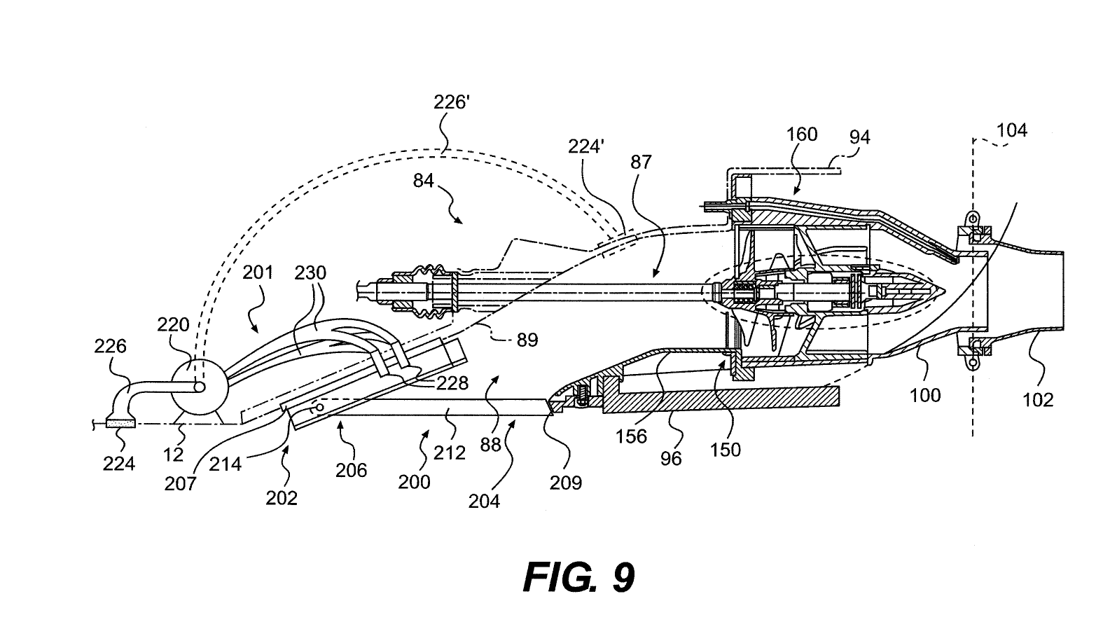

The steering nozzle 102 is operatively connected to the helm assembly 60 preferably via a push-pull cable (not shown) such that when the helm assembly 60 is turned, the steering nozzle 102 pivots. This movement redirects the pressurized water coming from the venturi 100, so as to redirect the thrust and steer the watercraft 10 in the desired direction. Optionally, the steering nozzle 102 may be gimbaled to allow it to move around a second horizontal pivot axis (as shown in FIGS. 8 and 9). The up and down movement of the steering nozzle 102 provided by this additional pivot axis is known as trim and controls the pitch of the watercraft 10.

When the watercraft 10 is moving, its speed is measured by a speed sensor 106 attached to the transom 54 of the watercraft 10. The speed sensor 106 has a paddle wheel 108 that is turned by the water flowing past the hull 12. In operation, as the watercraft 10 goes faster, the paddle wheel 108 also turns faster. An electronic control unit (ECU) (not shown) connected to the speed sensor 106 converts the rotational speed of the paddle wheel 108 to the speed of the watercraft 10 in kilometers or miles per hour, depending on the rider's preference. The speed sensor 106 may also be placed in the ride plate 96 or at any other suitable position. Other types of speed sensors, such as pitot tubes, and processing units could be used, as would be readily recognized by one of ordinary skill in the art. Alternatively, a global positioning system (GPS) unit could be used to determine the speed of the watercraft 10 by calculating the change in position of the watercraft 10 over a period of time based on information obtained from the GPS unit.

The watercraft 10 is provided with the ability to move in a reverse position. A reverse gate 110 which is movable between a first stowed position where it does not interfere with the jet of water (indicated by arrows 85) being expelled by the water jet propulsion system 84 and a plurality of positions where it redirects the jet of water 85 being expelled by the water jet propulsion system 84, thus causing the watercraft 10 to move in a reverse direction. A reverse gate actuator (not shown) is operatively connected to the reverse gate 110 to move the reverse gate 110. The reverse gate actuator could be any one of a mechanical, a hydraulic, or an electric actuator, such as an electric motor.

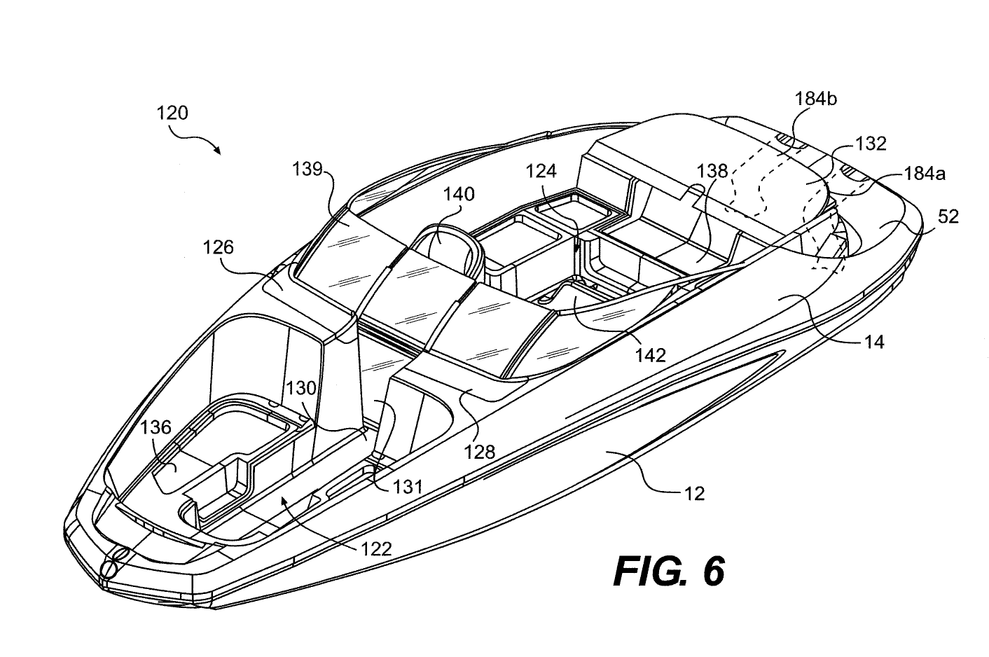

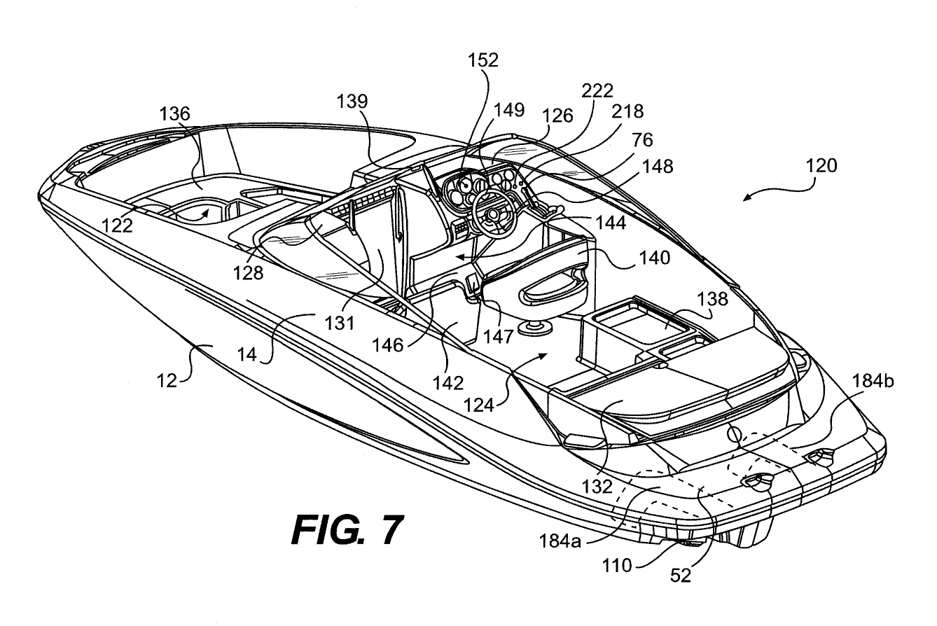

The general construction of a sport boat 120 in accordance with this invention will now be described with respect to FIGS. 6 and 7. The following description relates to one way of manufacturing a sport boat. Obviously, those of ordinary skill in the sport boat art will recognize that there are other known ways of manufacturing and designing sport boats and that this invention would encompass these other known ways and designs.

For simplicity, the components of the sport boat 120 which are similar in nature to the components of the personal watercraft 10 described above will be given the same reference numeral. It should be understood that their specific construction may vary however.

The sport boat 120 has a hull 12 and a deck 14 supported by the hull 12. The deck 14 has a forward passenger area 122 and a rearward passenger area 124. A right console 126 and a left console 128 are disposed on either side of the deck 14 between the two passenger areas 122, 124. A passageway 130 disposed between the two consoles 126, 128 allows for communication between the two passenger areas 122, 124. A door 131 is used to selectively open and close the passageway 130. In an embodiment of the invention, at least one engine is located between the hull 12 and the deck 14 at the back of the boat 120 and powers the water jet propulsion system (not shown) of the boat 120. In the embodiment of the invention shown in FIGS. 6 and 7, two engines power two jet propulsion systems 184a and 184b. Each water jet propulsion systems 184a and 184b has an inlet 86. The inlets 86 are disposed on opposite sides of a longitudinal axis of the sport boat 120. The water jet propulsion systems 184a and 184b are of similar construction as the water jet propulsion system 84 of the personal watercraft 10 described above. In an embodiment of the invention, at least one reverse gate 110 is operatively mounted to the hull 12. In the embodiment of the invention shown in FIGS. 6 and 7, one reverse gate 110 is provided for each of the two water jet propulsion systems 184a and 184b. The reverse gates 110 are of similar construction as the reverse gate 110 of the personal watercraft 10 described above, and will therefore not be described again. The engines are accessible through an engine cover 132 located behind the rearward passenger area 124. The engine cover 132 can also be used as a sundeck for a passenger of the boat 120 to sunbathe on while the boat 120 is not in operation. A reboarding platform 52 is located at the back of the deck 14 for passengers to easily reboard the boat 120 from the water.

The forward passenger area 122 has a C-shaped seating area 136 for passengers to sit on. The rearward passenger area 124 also has a C-shaped seating area 138 at the back thereof. A driver seat 140 facing the right console 126 and a passenger seat 142 facing the left console 124 are also disposed in the rearward passenger area 124. It is contemplated that the driver and passenger seats 140, 142 can swivel so that the passengers occupying these seats can socialize with passengers occupying the C-shaped seating area 138. A windshield 139 is provided at least partially on the left and right consoles 124, 126 and forwardly of the rearward passenger area 124 to shield the passengers sitting in that area from the wind when the boat 120 is in movement. The right and left consoles 126, 128 extend inwardly from their respective side of the boat 120. At least a portion of each of the right and the left consoles 126, 128 is integrally formed with the deck 14. The right console 126 has a recess 144 formed on the lower portion of the back thereof to accommodate the feet of the driver sitting in the driver seat 140 and an angled portion of the right console 126 acts as a footrest 146. A reverse gate operator, in the form of a foot pedal 147, is provided on the footrest 146. It is contemplated that the foot pedal 147 could be replaced by a handle positioned near or on the steering wheel 149. The function of the foot pedal 147 is similar to that of the reverse gate operator 77 of the personal watercraft 10. The left console 128 has a recess (not shown) similar to recess 144 to accommodate the feet of the passenger sitting in the passenger seat 142. The right console 126 accommodates all of the elements necessary to the driver to operate the boat. These include, but are not limited to, a helm assembly in the form of the steering wheel 149, a throttle operator 76 in the form of a throttle lever, and an instrument panel 152. The instrument panel 152 have various dials indicating the watercraft speed, engine speed, fuel and oil level, and engine temperature. The speed of the boat 120 is measured by a speed sensor (not shown) which can be in the form of the speed sensor 106 described above with respect to the personal watercraft 10 or a GPS unit or any other type of speed sensor which could be used for marine applications. It is contemplated that the elements attached to the right console 126 could be different than those mentioned above. The left console 128 incorporates a storage compartment (not shown) which is accessible to the passenger sitting the passenger seat 142.

Turning to FIG. 9, the water jet propulsion system 184a of a sport boat such as the sport boat of FIGS. 6 and 7 will now be described in more detail. The water jet propulsion system 184b of the sport boat of FIGS. 6 and 7 and the water jet propulsion system 84 of the personal watercraft 10 of FIGS. 1 to 5 are of similar construction as the water jet propulsion system 184a.

The water jet propulsion system 184a is disposed within the hull 12, only a portion of which is shown in broken lines to reveal the details of the water jet propulsion system 184a. The water jet propulsion system 184a includes an inlet 86 in the hull 12 that leads to a water intake ramp 88 in the tunnel 94. A pump support 150 is secured within the tunnel 94. The water intake ramp 88 is defined by an interior wall 89 and a ramp portion 156 of the pump support 150. The jet pump 160 is secured within the tunnel 94 to the pump support 150. The venturi 100 and the steering nozzle 102 that pivot about the vertical axis 104 are disposed at the rearward end of the tunnel 94. The inlet 86, intake ramp 88, tunnel 94, venturi 100 and steering nozzle 102 define a water passage 87 through which water used in the water jet propulsion system 184a is flowing.

Turning to FIGS. 9 to 13, the inlet grate 200 and embodiments of an inlet grate cleaning system 201 will now be described in more detail with respect to the sport boat 120. However, it should be understood that a similar system is used on the personal watercraft 10 having a single water jet propulsion system 84.

As shown in FIGS. 9 to 11, the inlet 86 has a forward area 202 and a rearward area 204.

As shown in FIGS. 9 to 12, the inlet grate 200 has a first end portion 206. The first end portion 206 of the inlet grate 200 includes a first plate 207. The first end portion 206 of the inlet grate 200 is adjacent to the forward area 202 of the inlet 86 and connected thereto through the first plate 207. In an embodiment of the invention, the first end portion 206 of the inlet grate 200 is connected to the inlet 86 by bolts (not shown) passing through apertures (not shown) defined in the first plate 207 of the inlet grate 200. It is contemplated that a seal (not shown) may be disposed between the first plate 207 of the inlet grate 200 and the forward area 202 of the inlet 86. It is also contemplated that in other embodiments of the invention, the inlet grate 200 could be disposed the other way around with respect to the inlet 86. In such embodiments of the invention, the first end portion 206 of the inlet grate 200 would be adjacent to the rearward area 204 of the inlet 86 and connected thereto through the first plate 207.

Elongated members 212 extend from the first end portion 206 of the inlet grate 200 toward the rearward area 204 of the inlet 86. In an embodiment of the invention shown in FIG. 9, the end of the elongated members 212 closer to the rearward area 204 of the inlet 86 are free and abut a recess 209 in the ride plate 96 when in a “closed” position.

In an embodiment of the invention, the inlet grate 200 is made of casted aluminum. It is contemplated that, in alternative embodiments of the invention, the various parts of the inlet grate 200 could be made of the same or various materials suitable for such use, including various plastics or composite material as well as various non-corrosive metallic materials such as stainless steel.

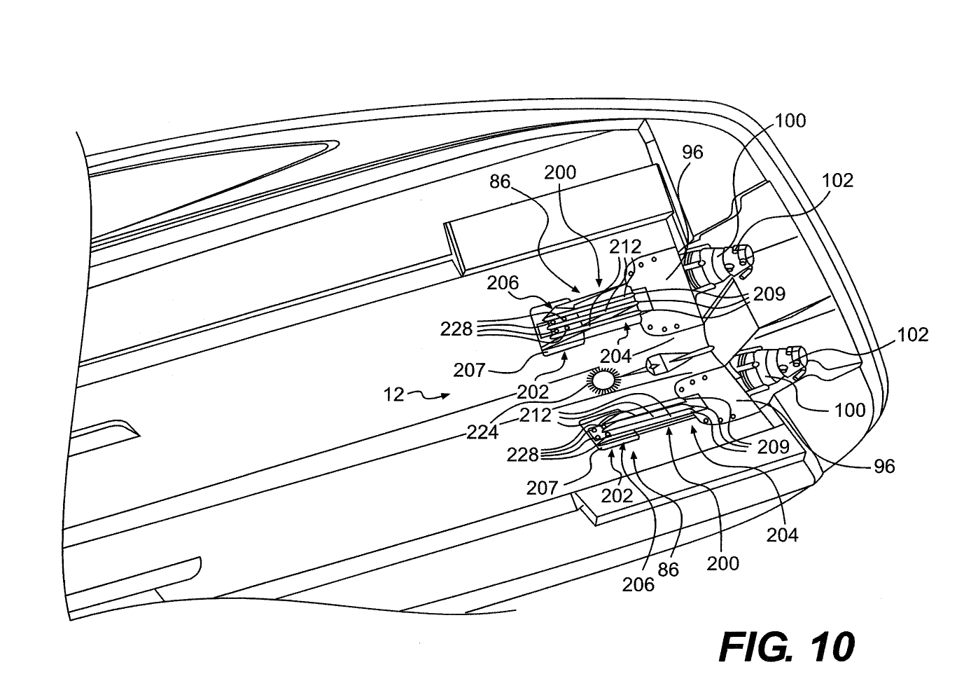

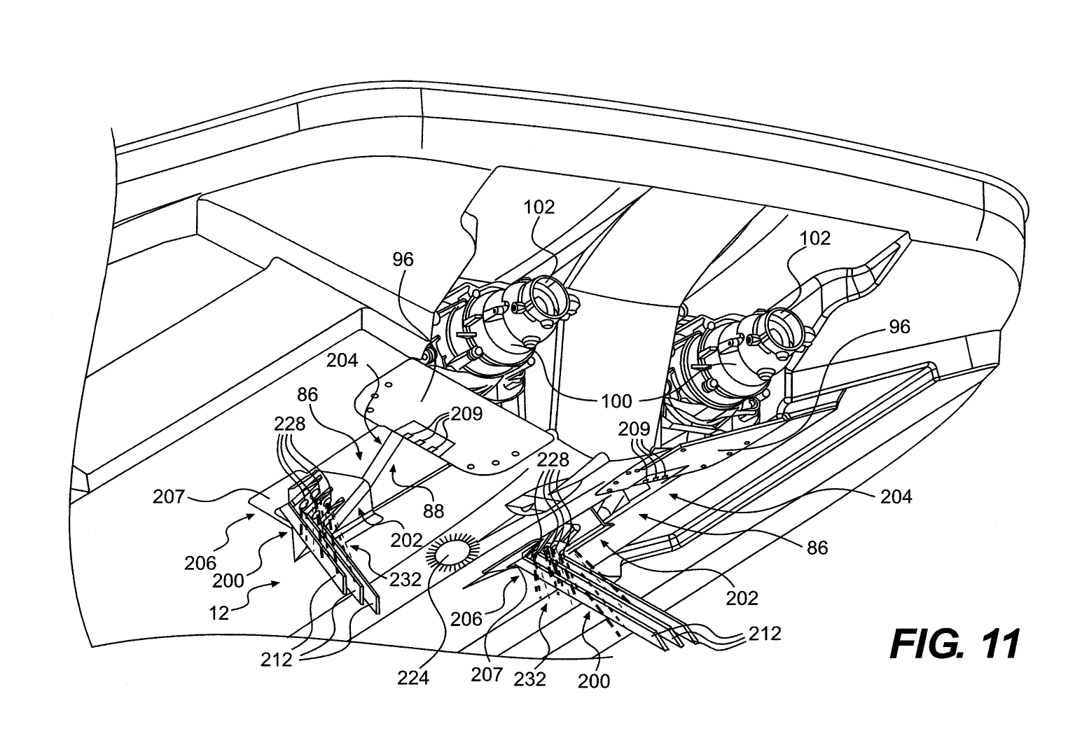

In the embodiment of the invention shown in FIGS. 9 to 12, the elongated members 212 are pivotally mounted to the first plate 207 of the inlet grate 200 via the shaft 214. Elongated members 212 can be moved from a first “closed” position where, as shown in FIGS. 9 and 10, elongated members 212 abut the recess 209, to a second “opened” position where, as shown in FIG. 11, the elongated members 212 define an angle with the hull 12 and extend below the hull 12. In this embodiment of the invention, the shaft 214 is disposed in the forward area 202 of the inlet 86 and the free ends of the elongated members 212 is in the rearward area 204 of the inlet 86 when in the first “closed” position. It is also contemplated that if the inlet grate 200 the other way around with respect to the inlet 86 as discussed above, the shaft 214 would be disposed in the rearward area 204 of the inlet 84 and the free ends of the elongated members 212 in the forward area 202 of the inlet 86.

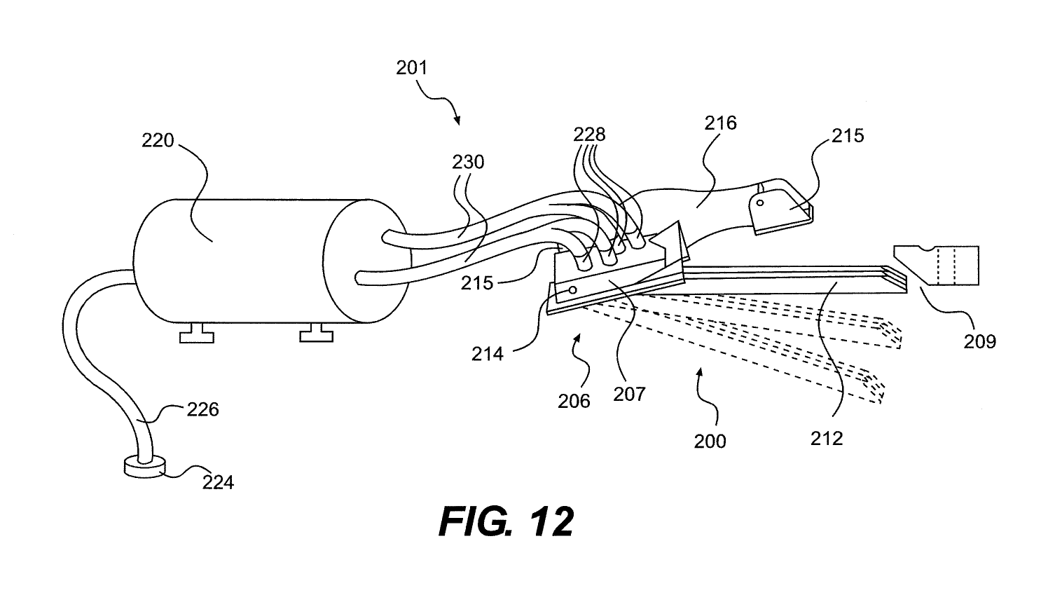

As shown in FIG. 12, an actuator 216, in this embodiment of the invention an electric motor (not shown) covered by a housing to protect it from infiltration of water, is operatively connected to the shaft 214 via a shaft and bevel gears (not shown). The housing of the actuator 216 is also connected to the hull 12 via brackets 215. It is contemplated that the actuator 216 could be any type of actuator, such as a mechanical, hydraulic or electric actuator. It is also contemplated that the elongated members could be pivoted via a shaft and lever assembly (not shown) operated an operator of the watercraft.

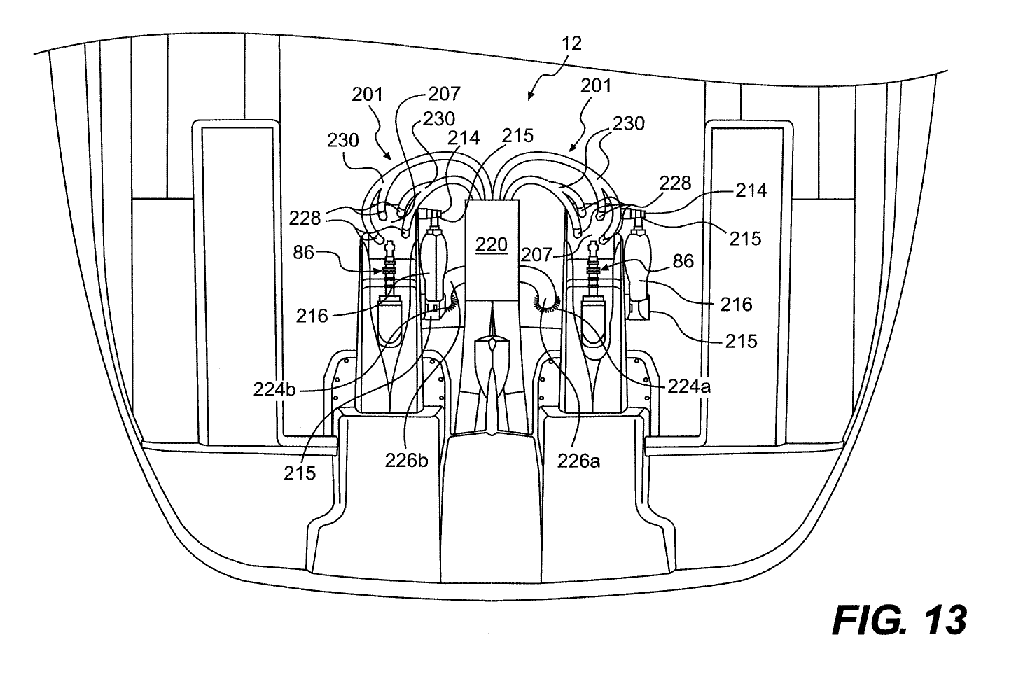

In the embodiment of the invention shown in FIGS. 12 and 13, the actuator 216 is controlled through a device disposed within reach of an operator of the watercraft. In the embodiment of the invention shown in FIG. 7, the device comprises a first button 218 alternatively commending the downward and upward movements of the elongated members 212.

As shown in FIGS. 9 and 12, a pump 220 is connected to the inside wall of the hull 12. In other embodiments of the invention, the pump 220 could be disposed at any suitable location on the watercraft, including on the deck 14. The pump 220 is controlled through a device disposed with reach of an operator of the watercraft. In the embodiment of the invention shown in FIG. 7, the device comprises a second button 222 controlling the operation of the pump 220. It is contemplated that the first button 218 and second button 222 could be a single button (not shown) controlling both the actuator 216 and pump 220.

As shown in FIGS. 9 to 12, a water intake 224 is disposed in the hull 12 and is connected to the pump 220 through a hose 226. In an alternative embodiment of the invention, the water intake 224′ could be disposed in the water passage 87, preferably in the interior wall 89 of the water intake ramp 88, and connected to the pump 220 through the hose 226′. In another alternative embodiment of the invention shown in FIG. 13, two water intakes 224a and 224b are disposed in the hull 12 and connected to the pump 220 through two hoses 226a and 226b. In other embodiments of the invention, water intakes 224a and 224b are respectively connected to a first pump (not shown) and a second pump (not shown) through hoses 226a and 226b respectively.

As shown in FIGS. 9 to 12, four nozzles 228 are connected to the first plate 207 of the inlet grate 200. The nozzles 228 are positioned so as to point downward toward each of the elongated members 212 of the inlet grate 220 when these elongated members 212 are pivoted to a second “opened” position. As shown in FIGS. 9 and 12, the four nozzles 228 are connected to the pump 220 through hoses 230. It is contemplated that in alternative embodiments of the invention, only one nozzle 228 may be sufficient. In yet other embodiments of the invention, more than four nozzles 228 may be disposed in various areas of the inlet 86.

To operate the inlet grate cleaning system 201, an operator of the watercraft presses the first button 218 to pivot the elongated members 212 of the inlet grate 200 from a first “closed” position where the ends of the elongated members 212 abut the recess 209, to a second “opened” position where the elongated members 212 define an angle with the hull 212 below the hull 212. The operator of the watercraft then presses the second button 222 to activate the pump 220 which pumps water from the body of water on which the watercraft is operated through the water intake 224 to the four nozzles 228 to create four jets of water 232 oriented toward various regions of the inlet grate 220, including the elongated members 212 in order to loosen and remove objects, including weeds, pieces of weed, small rocks and dirt, stuck to the inlet grate 200. Once he is satisfied that the inlet grate 220 has been properly cleaned, the operator of the watercraft presses the first button 218 again to pivot the elongated members 212 of the inlet grate 200 from the second “opened” position described above to the first “closed” position described above.

It is contemplated that the inlet grate 200 and elongated members 212 could be fixed and that cleaning of the inlet grate 200 may be accomplished solely through the use of the jets of water 232.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. An inlet grate cleaning system for a water jet propulsion system to be used in a watercraft, the water jet propulsion system having a water passage, the water passage having an inlet, the inlet having a forward area and a rearward area with respect to the watercraft, the inlet grate cleaning system comprising:
a pump;
at least one water intake fluidly connected to the pump; and
at least one water outlet fluidly connected to the pump,
the pump being adapted for pumping water from the at least one water intake to the at least one water outlet to create at least one jet of water, and
the at least one water outlet being positioned so as to direct the at least one jet of water toward an inlet grate.

2. An inlet grate cleaning system of claim 1, wherein the at least one water outlet includes a nozzle.

3. An inlet grate cleaning system of clam 1, further comprising:
an inlet grate comprising: a first end portion adapted to be connected to one of the forward area and the rearward area of the inlet; and
at least one elongated member extending from the first end portion toward the other of the forward area or the rearward area of the inlet, and
the at least one elongated member being pivotally mounted to the first end portion of the inlet grate.

4. An inlet grate cleaning system of claim 3, wherein the at least one water outlet is positioned at the first end portion of the inlet grate.

5. An inlet grate cleaning system of claim 3, wherein the at least one water outlet includes a nozzle.

6. An inlet grate cleaning system of claim 3, further comprising an actuator operatively connected to the at least one elongated member to pivot the at least one elongated member of the inlet grate between a first position and at least a second position.

7. An inlet grate cleaning system of claim 3, further comprising a device operatively connected to the actuator for controlling the operation of the actuator.

8. A watercraft comprising:
a hull;
a deck disposed on the hull;
a water jet propulsion system connected to the hull and having a water passage, the water passage having an inlet, the inlet having a forward area and a rearward area with respect to the watercraft;
an engine supported by the hull and adapted to drive the water jet propulsion system;
an inlet grate disposed in the inlet;
a pump connected to one of the hull or the deck;
at least one water intake fluidly connected to the pump; and
at least one water outlet fluidly connected to the pump,
the pump being adapted for pumping water from the at least one water intake to the at least one water outlet to create at least one jet of water, and
the at least one water outlet being positioned so as to direct the at least one jet of water toward the inlet grate.

9. A watercraft of claim 8, wherein at least one portion of the inlet grate is pivotally mounted to one of the forward area of the inlet or the rearward area of the inlet.

10. A watercraft of claim 9, further comprising:
an actuator operatively connected to the at least one portion of the inlet grate;
the actuator being adapted to cause the at least one portion of the inlet grate to pivot between a first position and at least a second position away from the hull.

11. A watercraft of claim 10, further comprising:
a device operatively connected to the actuator for controlling the operation of the actuator,
the device being disposed on the deck so as to be within reach of an operator of the watercraft.

12. A watercraft of claim 8, wherein the inlet grate has a first end portion adapted to be connected to one of the forward area or the rearward area of the inlet and at least one elongated member extending from the first end portion toward the other of the forward area or the rearward area of the inlet, the at least one elongated member being pivotally mounted to the first end portion of the inlet grate.

13. A watercraft of claim 12, further comprising an actuator operatively connected to the at least one elongated member to pivot the at least one elongated member of the inlet grate between a first position and at least a second position away from the hull.

14. A watercraft of claim 13, further comprising:
a device operatively connected to the actuator for controlling the operation of the actuator,
the device being disposed on the deck so as to be within reach of an operator of the watercraft.

15. The watercraft of claim 8, further comprising:
a straddle seat disposed on the deck; and
a handlebar operatively connected to the jet propulsion system for steering the watercraft.

16. The watercraft of claim 8, wherein the water jet propulsion system is a first water jet propulsion system having a first water passage, the first water passage having a first inlet, the inlet grate is a first inlet, the at least one water outlet is at least one first water outlet, the watercraft further comprising:
a second water jet propulsion system having a second water passage, the second water passage having a second inlet;
a second inlet grate disposed in the second inlet;
at least one second water outlet fluidly connected to the pump;
the pump being adapted for pumping water from the at least one water intake to the at least one second water outlet to create at least one second jet of water, and
the at least one second water outlet being positioned so as to direct the at least one second jet of water toward the second inlet grate.

17. The watercraft of claim 16, wherein the first inlet and the second inlet are on opposite sides of a longitudinal axis of the watercraft.

18. A method for cleaning an inlet grate for a water jet propulsion system to be used in a watercraft, the water jet propulsion system having a water passage, the water passage having an inlet, the inlet having a forward area and a rearward area with respect to the watercraft, and an inlet grate disposed in the inlet, the method comprising:
pumping water through a water intake from a body of water in which the watercraft is operated to at least one water outlet to create at least one jet of water directed toward the inlet grate.

19. The method of claim 18, wherein the inlet grate has an end portion connected to the inlet and at least one elongated member extending from the end portion, the method further comprising:
pivoting the at least one elongated member of the inlet grate between a first position and at least a second position away from the hull of the watercraft;
wherein the at least one jet of water is directed toward the at least one elongated member when the at least one elongated member is in the at least second position.
